(19) United States
(12) Patent Application Publication
(10) Pub. No.: US 2017/0291140 A1
(43) Pub. Date: Oct. 12, 2017

(54) THERMALLY STABLE NH3-SCR CATALYST COMPOSITIONS

(71) Applicant: TREIBACHER INDUSTRIE AG, Treibach-Althofen (AT)

(72) Inventors: Karl Schermanz, Launsdorf (AT); Amod Sagar, Althofen (AT)

(21) Appl. No.: 15/507,060

(22) PCT Filed: Sep. 21, 2015
(86) PCT No.: PCT/EP2015/071596

§ 371 Date: Feb. 27, 2017

(30) Foreign Application Priority Data
Sep. 22, 2014 (EP) 14185803.5

(51) Int. Cl. B01D 53/94; B01J 23/00; B01J 37/02; B01J 29/40; B01J 29/70; B01J 23/18; B01J 29/06

(52) U.S. Cl. CPC B01D 53/9418; B01J 23/18; B01J 23/002; B01J 29/061; B01J 29/405; B01J 29/7057; B01J 37/0246

(57) ABSTRACT

A catalyst composition comprising a mixture of
(a) a zeolite compound in an amount of from 10% to 60% by weight, wherein the zeolite compound comprises cations selected from Fe²⁺, Fe³⁺, Cu⁺, Cu²⁺ or mixtures thereof, and
(b) a ceria/zirconia/alumina composite oxide, wherein the alumina content in said composite oxide is in the range of 20 to 80% by weight, in particular of 40 to 60% by weight,
   a catalyst comprising such catalyst composition and its use for exhaust gas after-treatment of diesel and lean burn engines.

The present invention relates to thermally stable catalyst compositions for use in an NH₃-SCR process for Selective Catalytic Reduction (SCR) of NOₓ in exhaust gases.

Such catalyst compositions may be used particularly in exhaust gas after-treatment of diesel-and lean burn engines of mobile applications such as automotive and non-road applications.

### BACKGROUND OF THE INVENTION

Diesel- and lean burn engines produce harmful exhausts which contain CO, hydrocarbons, particulate matters and reasonable amounts of NOₓ. Therefore already regulations have been set up worldwide which limit the emissions of all the harmful components produced by the engines. Particularly the NOₓ emission limits are still developing to lower values which require the use of more efficient Selective Catalytic NOₓ Reduction (DeNOₓ) catalysts in future.

In the last decade, two main approaches towards NOₓ reduction have been proposed: NOₓ storage and reduction (NSR) technology and NOₓ selective catalytic reduction (SCR). SCR was originally developed for stationary emission sources, mainly power plants. However it soon turned out to be a promising technology for NOₓ removal in automotive applications as well.

NOₓ can be reduced in a diesel exhaust gas by a process commonly known as Selective Catalytic Reduction (SCR) process. A SCR process involves the conversion of NOₓ in the presence of a SCR-catalyst and with the aid of reducing agents, e.g NH₃.

In the NH₃-SCR process, gaseous ammonia is added to an exhaust gas stream prior to contacting the exhaust gas with the SCR catalyst. The reductant is adsorbed onto the catalyst and NOₓ reduction takes place as the gases pass through or over the catalyzed substrate. In a NH₃-SCR converter, the most widely used external source for ammonia is urea. The urea solution may be injected in a controlled way into the exhaust line, where it is thermally decomposed into NH₃ and CO₂. The ammonia then reacts with NOₓ giving N₂ as final product.

An overview on the currently applied NH₃-SCR technology is e.g. disclosed by O. Kröcher, Chapter 9 in <<Past and Present in DeNOₓ Catalysis>>, edited by P. Granger et al., published by Elsevier 2007. In that publication there are described several classes of catalyst which are applied in DeNOₓ application, such as Vanadia based catalysts and zeolite based catalysts.

One class of SCR catalysts that has been investigated for treating NOₓ from internal combustion engine exhaust gas is transition metal exchanged zeolites, e.g. as reported in U.S. Pat. No. 4,961,917 A. However, in use such zeolites eg. ZSM-5 and beta zeolites have a number of drawbacks. They are sensitive to hydrothermal ageing and hydrocarbons resulting in a loss of activity.

In EP 0 234 441 a catalyst for selective catalytic reduction of NOₓ to N₂ in the presence of NH₃ in the form of composite bodies formed from a mixture of 5 to 50% by weight, 50 to 90% of a zeolite, 0-30% of a binder and optionally a promoter selected from oxides of vanadium and copper in the amount of at least 0.1% by weight. In such catalysts ZrO₂ is described to hayed a specific surface area of 10 m²/g. The zeolites used preferably are clinoptilolite, optionally a blend with chabazite. NOₓ conversion of such catalyst is disclosed only at 350° C. No examples are given regarding NOₓ conversion at temperatures below, particularly at temperatures from 250° C. to 300° C. which temperature range is highly of importance in today's applications. A valuable SCR catalyst has to convert NOₓ preferably already at temperatures in the range of 200-250° C., immediately after the engine is started.

In US 2010/221160 a catalyst body that includes ceria/zirconia and a metal-zeolite is described. The ceria and zirconia mixed oxides are present in the catalyst in a maximum amount of 50 weight %, the rest being a Fe-zeolite compound. Mixtures comprising Ce—Zr mixed oxide in more than 50 weight % are not disclosed. The catalyst compositions are tested on NOₓ performance in an ageing process at 700° C./6 hours.

WO 2011/006062 relates to a Diesel Particulate Filter (DPF) with a SCR catalyst and a method for selectively reducing nitrogen oxides with ammonia, filtering particulates and reducing the ignition temperature of soot on a DPF. The catalyst includes a first component of Cu, Cr, Co, Ni, Mn, Fe, Nb, or mixtures thereof, a second component of Cerium, lanthanide, a mixture of lanthanides, or a mixture thereof and a component characterized by increased surface acidity. The catalyst may also include Sr as second component. The catalyst is described to selectively reduce nitrogen oxides to nitrogen with ammonia and oxidizes soot at low temperatures. The catalyst has high hydrothermal stability. It provides an excellent multipurpose catalyst but contains zeolites in an amount more than 45 wt %, in addition to the presence of Sr which may be used to increase the oxygen storage capacity of the catalyst. The oxygen storage material which is present in the catalyst composition is based on Ce/Zr/Rare Earths oxides or mixtures thereof only. The Oxygen Storage material does not comprise any composite oxide based on Ce/Zr/Al (ACZ). As disclosed in WO 2011/006062, an efficient catalyst is highly complex as it consists of multi different components by all means of mixtures out of 3 different materials.

In US 2011/142737 a catalyst and a process for selective catalytic reduction of nitrogen oxides in diesel engine exhaust gases with ammonia or a compound decomposable to ammonia is disclosed. The exhaust gas catalyst comprises a zeolite or zeolite like compound containing 1-10% by weight of Cu, based on the total weight of zeolite or zeolite like compound and a homogeneous cerium-zirconium mixed oxide and/or Cerium oxide. Additionally for making an SCR catalyst more than 50 wt % of zeolite or zeolite like compound containing 1-10 wt % of Cu is used in combination with cerium zirconium oxide. Moreover La-stabilized alumina is used for stabilizing followed by SiO₂ “silica sol” as a binder. The catalyst mixtures disclosed are compositions in which the amount of Zeolite is between 60 and 80 weight % but not less.

U.S. Pat. No. 8,617,497 relates to the use of mixed oxides made of cerium oxide, zirconium oxide, rare earth sesquioxide and niobium oxide as catalytically active material for SCR of nitrogen oxides with NH₃ in exhaust gas of internal combustion engines in motor vehicles that are predominantly leanly operated. Compositions or catalysts which contain said mixed oxides in combination with zeolite compounds and/or zeolite like compounds and which are described to be suitable for denitrogenation of lean motor vehicle exhaust gases in all essential operating states are also disclosed. Zeolites or zeolite like compounds here are added to said mixed oxides in order to enhance the NH₃ storage capacity and widening the activity temperature range of mixed oxides that already exhibit NOₓ conversion activity. All the catalyst compositions disclosed in U.S. Pat. No. 8,617,497 refer to the use of mixed oxides containing Nb.

Nb containing mixed oxides e.g. are also known from EP 2 368 628, WO 2011/117047, or Applied Catalysis B: Environmental 103(2011) 79-84. The Nb containing Ce/Zr mixed oxides are known to have a high NH₃-DeNOₓ activity by itself.

As a summary of the state of the art review, it may be concluded that zeolites often are combined with other active SCR materials to reduce either the amounts of zeolites in the mixtures or/and to achieve improved properties of the catalyst mixtures.

It is known also, e.g. from EP 1 172 139, WO 2013/004456, WO 2013/007809 ceria/zirconia/rare earth-alumina composite oxides may be applied for catalyst applications. However, such components are mainly used in the field of three way catalysts. The Ce/Zr/Al composite oxides itself namely do show very low, or even almost no SCR activity. Such Ce/Zr/Al composite oxides regarding their SCR properties are therefore totally different from Nb based mixed Ce/Zr/mixed oxides as disclosed e.g. in Applied Catalysis B: Environmental 103(2011) 79-84 and which are applied for combinations with zeolites as disclosed in U.S. Pat. No. 8,617,497.

U.S. Pat. No. 6,335,305 B1 discloses a catalyst for purifying an exhaust gas including a ceria-zirconia composite oxide. The catalysts disclosed in this document are 3-way catalysts including a noble metal, such as platinum or rhodium. SCR catalysts do not include noble metals. According to example 6 of this document, a composite oxide of Ce/Zr/Al and La is mixed with mordenite. Mordenite is a zeolite having no Fe or Cu cations.

US 2010/166629 discloses an oxidation catalyst comprising a first washcoat layer comprising a support material selected inter alia from ceria-zirconia-alumina and a noble metal catalyst, wherein said first washcoat layer does not contain a zeolite.

US 2010/0190634 discloses a NOₓ purifying catalyst comprising a first catalyst layer and a second catalyst layer. This document does not disclose the use of composite oxides of Ce/Zr/Al.

US 2012/0294792 discloses a catalyst for SCR comprising phase pure lattice oxide materials. This document does not disclose the use of composite oxides of Ce/Zr/Al. Furthermore, the pure lattice oxide materials disclosed in this document are already very SCR-active on their own. As will be shown below, a Ce/Zr/Al composite oxide exhibits only a very low SCR-activity on its own.

US 2014/0044629 discloses Ce/Zr/Nb oxides which already have a very high SCR activity on their own.

US 2012/0141347 discloses the use of various mixed oxides of ZrO₂ and ceria/zirconia doped with Fe and W which already have very high SCR performance on their own.

US 2003/0073566 A1 and US 2013/0156668 A1 discloses NOₓ reduction catalysts. Neither of these documents discloses the use of composite oxides of Ce/Zr/Al.

It was now surprisingly found that ceria/zirconia/alumina composite oxides which themselves exhibit very low SCR activity, on combination with a zeolite compound which contains copper and/or iron cations, exhibit an excellent sustaining SCR activity of the mixture even when the amount of the Alumina Ce—Zr-Oxide compound is above 75% and the zeolite is 25% of weight only or even less.

In one aspect the present invention provides a catalyst composition comprising a mixture of
(a) a zeolite compound in an amount from 10% to 60% by weight, wherein the zeolite compound comprises exchangeable cations selected from Fe²⁺, Fe³⁺, Cu⁺, Cu²⁺ or mixtures thereof, and
(b) a ceria/zirconia/alumina composite oxide, wherein the alumina content in said composite oxide is in the range from 20 to 80% by weight.

A “ceria/zirconia/alumina composite oxide” as used herein means a composite composed of cerium oxide, zirconium oxide and aluminium oxide and correspondingly, a “ceria/zirconia composite” means a composite composed of cerium oxide and zirconium oxide.

As known to the skilled artisan, a composite oxide, which can e.g. be obtained via a co-precipitation method or a wet-cake method as discussed further below, differs from a mere physical mixture of several oxides in various aspects.

A catalyst composition provided by the present invention is herein designated also as “composition (according to) of the present invention”. A catalyst provided by the present invention is herein designated also as “catalyst (according to) of the present invention”.

In the catalyst composition of the present invention, noble metals are absent.

Especially, the catalyst composition of the present invention preferably essentially consists of components a) and b) above.

Zeolite compounds are known and include microporous, aluminosilicate minerals commonly used as commercial adsorbents and catalysts. Zeolites occur naturally but are also produced industrially on a large scale. Some of the more common mineral zeolites are analcime, chabazite, clinoptilolite, heulandite, natrolite, phillipsite, and stilbite. Zeolites have a porous structure that can accommodate a wide variety of cations, such as Na⁺, K⁺, Ca²⁺, Mg²⁺ and others. These positive ions are rather loosely held and can readily be exchanged for others e.g. Fe²⁺, Fe³⁺, Cu⁺ and Cu²⁺, in a contact solution. For the purpose of the present invention the term “zeolite compound” includes also “zeolite-like compounds”.

The zeolite compound of the present invention contains Fe and/or Cu cations, i.e. Fe²⁺, Fe³⁺, Cu⁺ and/or Cu²⁺ cations, especially in an amount of 0.05-15 weight % of the metal, preferably 0.1-10 weight % of the metal, most preferably 1-6 weight % of the metal, based on the weight of the zeolite including the cations. The zeolite compound which may be used according to the present invention and into which a Cu and/or Fe cation can be introduced by known methods is preferably selected from the group consisting of beta zeolite, USY (ultrastable Y), ZSM-5 (Zeolite Socony Mobile 5 also known as MFI), CHA (chabazite), FER (ferrierite), ERI (erionite), SAPO (silicoaluminophosphates) such as SAPO 11, SAPO 17, SAPO 34, SAPO 56, ALPO (amorphous aluminophospates), such as ALPO 11, ALPO 17, ALPO 34, ALPO 56, SSZ-13, ZSM-34 and mixtures thereof.

Appropriate metal exchanged zeolites according to the present invention may possess MFI, BEA (zeolite beta) or FER structure. Such zeolites are commercially available, e.g. from the company CLARIANT and can be e.g. produced following the synthesis procedure as described in WO 2008/141823.

The synthesis of a Cu-Chabazite is described e.g. in EP 2551240 and US 2014/0234206A1. A Fe containing Zeolite of Beta and Chabazite structure respectively is described in US 2013/0044398. The preparation of a 5% Fe-Beta or SAPO 34 zeolite is described in EP 2 150 328 B1. 3% Cu-Zeolites of the type SAPO34, SSZ 13, ZSM 34 are described in EP 2 150 328 B1.

The zeolite compound is present in a composition of the present invention in an amount of from 10% to 60% by weight, such as 25% to 55% by weight, e.g. 30% to 50% by weight.

A catalyst composition according to the present invention comprises a ceria/zirconia/alumina composite oxide, wherein optionally a dopant may be present, particularly one or more other metal oxide(s), such as a rare earth metal oxide(s) other than Ce oxide, earth alkali metal oxide(s), such as Mg, Ca, Sr, Ba oxide, or an oxide wherein the metal is selected from Mn, Fe, Ti, Sb or Bi, or mixtures thereof.

A ceria/zirconia/alumina composite oxide in a catalyst composition of the present invention preferably is of formula

(Al₂O₃)ₓ(CeO₂)_{y}(ZrO₂)_{z}(M-oxide)ₐ

wherein
x denotes a number from 20% to 80% by weight,
y denotes a number from 5% to 40% by weight,
z denotes a number from 5% to 40% by weight and
a denotes a number from 0% to 15% by weight, with the proviso that x+y+z+a=100% by weight, and
M denotes a rare earth metal cation other than a Ce cation, an earth alkali metal cation, in particular a Mg, Ca, Sr or Ba cation, or a cation selected from a Mn, Fe, Ti, Sb or Bi cation; or M denotes individual mixtures of such cations.

In a ceria/zirconia/alumina composite oxide which is present in a composition of the present invention the amount of alumina is in the range from 20% to 80% by weight, e.g. 35% to 80% by weight, such as 35% to 60% by weight, e.g. 40% to 60% by weight.

In a ceria/zirconia/alumina composite oxide which is present in a composition of the present invention the amount of ceria, such as CeO₂, is in the range of 5% to 40% by weight.

In a ceria/zirconia/alumina composite oxide which is present in a composition of the present invention the amount of zirconia, such as ZrO₂ is in the range of 5% to 40% by weight.

In a ceria/zirconia/alumina composite oxide which is present in a composition of the present invention the amount of M-oxide(s) is in the range of 0% to 15% by weight.

The ceria/zirconia/alumina composite oxides in a composition of the present invention may be prepared as appropriate. The co-precipitation route, e.g. as disclosed in EP 1 172 139 or WO 2013/004456 may be applied. Alternatively also other preparation routes, e.g. where the Ce/Zr/Al composite oxides are made from ceria/zirconia wet cakes and various boehmites, such as disclosed in WO 2013/007809. A preferred Boehmite used in such process has pore volumes of 0.4 to 1.2 ml/g and/or crystallite sizes of 4 to 40 nm, preferably 4 to 16 nm, measured at the (120) reflection. Further methods for preparing ceria/zirconia/alumina composite oxides are disclosed in WO 2013/007242.

The Al₂O₃ content of the mixed oxides is in the range of 20 to 80% by weight, the rest preferably being a ceria/zirconia optionally doped with other rare earth oxide(s) and/or non rare earth metal oxide(s).

The ceria/zirconia/alumina composite oxide which is present in a composition of the present invention may differ in thermal stability with regard to surface area. Preferably there are used ceria/zirconia/alumina composite oxides exhibiting a surface area of 2 to 50 m²/g after calcination at 1100° C. for 2 hours, but also “enhanced ceria/zirconia/alumina composite oxides”, such as disclosed in WO 2013/007809, may be applied having a surface area of 50 to 100 m²/g after calcination at 1100° C./2 hours.

In a further aspect the present invention provides a catalyst comprising a substrate coated with a catalyst composition according to the present invention, e.g. wherein the substrate is selected from the group consisting of cordierite, mullite, Al-Titanate or SiC.

The catalyst according to the present invention preferably is not a zone catalyst comprising several zones or layers of different catalyst compositions. I.e. the catalyst of the present invention essentially consists of the substrate and the catalyst composition according to the present invention coated thereon.

In another aspect the present invention provides the use of a catalyst composition, or of a catalyst according to the present invention in exhaust gas after-treatment of diesel and lean burn engines, particularly of diesel and lean burn engines of automotives and for non-road applications, in particular of automotives. Especially, the catalyst composition or the catalyst according to the present invention may be used for Selective Catalytic Reduction (SCR) of NOₓ in exhaust gases.

For the preparation of a catalyst of the present invention the zeolite compound and the ceria/zirconia/alumina composite oxides may be physically mixed prior to the coating. In another embodiment, the zeolite compound and the ceria/zirconia/alumina composite oxides may be combined in a slurry, which then is used for coating a substrate.

The catalyst (composition)s obtained according to the present invention may be substantially free of vanadium and have been found to be highly efficient in DeNOₓ abatement.

Furthermore it was demonstrated (examples 1 and 2) that a mixture based on 50% zeolite and 25% zeolite, respectively exhibit an increased NOₓ performance after ageing in the high temperature operation range of 450 to 500° C. compared with the comparison example 2 wherein the zeolite is applied without any mixed oxide (as 100% zeolite).

It has been further shown, that a certain amount of Ce and Zr inevitably must be present in a catalyst (composition) of the present invention in order to show a good DeNOₓ performance. A mixture which is prepared from Al₂O₃ and the zeolite compound alone exhibits rather decreased DeNOₓ performance in comparison with a material which contains a ceria/zirconia mixture in addition.

The Ce/Zr/Al composite oxides itself show very low or almost no SCR activity as shown in comparative example 1 and, as already indicated above such compounds therefore are totally different in their SCR properties from Nb based mixed Ce—Zr-mixed oxides.

Furthermore it has been shown, that mixtures of Zeolites and Ce/Zr/Al composite oxides as used in the present application do show a higher SCR activity in comparison to a mixture of Zeolite and a Ce/Zr/Al oxide mixture in which the Ce/Zr/Al-Oxide mixture was prepared by physically mixing the individual oxides of Al, Ce and Zr (see example 2 and comparative example 4).

### Conditions for Catalytic Testing:

For catalytic testing on NOₓ removal efficiency, the compositions were subjected to catalytic testing using a device as described in U.S. Pat. No. 8,465,713, FIG. 1.

### Sample Preparation

Powders prepared according to the present invention were pressed into pellets, crushed and sieved in the range 355-425 μm.

### Heat Treatment (Ageing)

For determination of the catalytic activity after heat treatment the sieved powders were subjected to calcination (ageing) in a static muffle furnace under air atmosphere at 700° C./10 hours.

### Measurement of Catalytic Activity

As a model feed gas for NOₓ, component there was used NO only. More in detail the feed consisted of NH₃/N₂, NO/N₂, O₂, N₂. Mass flow meters were used to measure and control the single gaseous stream while an injection pump was used to introduce water. The feed stream was preheated and premixed and ammonia was added to the gaseous mixture immediately before entering the reactor to avoid side reactions. A tubular quartz reactor was employed inserted in a furnace. Temperature was controlled by a thermocouple inserted in the catalyst bed. Activity of the catalysts was measured under stationary as well as dynamic conditions (ramp 5° C./minute) in a temperature range of 200° C. to 500° C. There were no major differences in the results between the 2 methods applied.

Gas composition analysis was carried out with an FT-IR spectrometer (MKS Multigas Analyzer 2030) equipped with a heated multi-pass gas cell (5.11 m).

In Table 1 below there are set out reaction conditions and gas composition for catalytic test A.

TABLE 1

| | |
|---|---|
| Catalyst weight | 100.0 mg |
| Particle size | 355-425 μm |
| Total flow | 0.3 l/min |
| Space velocity | 180.000 h⁻¹ |
| Temperature | 200-500° C. |
| | (Stationary or with |
| | ramp 5° C./min) |
| NO conc. | 200 ppm |
| NH₃ conc. | 220 ppm |
| O₂ conc. | 20000 ppm |
| H₂O conc. | 10% |
| N₂ conc. | balance |

Indications in “%” herein refer to “weight %” if not specified otherwise.

### Preparation of Ceria/Zirconia/Alumina—Composite Oxides

A) Preparation of Composite Oxide Al₂O₃ (50%) ZrO₂(32.5%) CeO₂(15%) Nd₂O₃(2.5%)

370.37 g of aluminium nitrate nonahydrate (Al₂O₃ 13.5%), 131.05 g of zirconyl-nitrate solution (ZrO₂ 24.8%), 53.19 g of cerium nitrate solution (CeO₂ 28.2%), and 6.59 g of neodymium nitrate crystals (Nd₂O₃ 37.93%) were dissolved in 1193 mL of deionised water and the mixture obtained was stirred for a few minutes until the solution became clear. To the aqueous mixed metal nitrate solution, 226.89 mL of cooled (10° C.) 35% H₂O₂ was added and the mixture obtained was stirred for approximately 45 minutes. Precipitation was done by adding drop wise 24% aqueous ammonia solution (10° C.) at room temperature with a dropping rate of 40 mL/minute and a pH of 10 was adjusted. The precipitate obtained was stirred at room temperature for additional 30 minutes and then filtered and washed with de-ionised water. The filter cake obtained was dried overnight at 120° C. and then calcined at 850° C. to get 100 g of composite oxide. The mixed composite oxide was pulverized in an agate mortar and sieved through 100 μm sieve. BET was measured at 850° C./4 hours (fresh material) and 1100° C./4 hours.

BET (fresh prepared material): 103 m²/g

BET (after ageing) at 1100° C./4 hours: 31.7 m²/g

B) Preparation of Composite Oxide Al₂O₃ (50%) ZrO₂(20%) CeO₂(20%) Bi₂O₃(10%)

370.37 g of aluminium nitrate nonahydrate (Al₂O₃ 13.5%), 80.65 g of zirconyl-nitrate solution (ZrO₂ 24.8%) and 70.92 g of cerium nitrate solution (CeO₂ 28.2%) were dissolved in 1211 mL of deionised water and the mixture obtained was stirred for a few minutes until the solution became clear. On the other hand, 20.82 g bismuth nitrate (Bi₂O₃ 48.03%) were suspended in 150 mL of deionised water and slowly added conc. HNO₃ (approximately 30 mL) with effective stirring till it dissolves completely. Bismuth nitrate solution so obtained was mixed with mixed metal nitrate solution and the mixture was stirred for additional 15 minutes at room temperature. To the aqueous mixed metal nitrate solution obtained was added drop wise 24% aqueous ammonia solution (10° C.) at room temperature with a dropping rate of 40 mL/minute and a pH of 9.5 was adjusted. The precipitate obtained was stirred at room temperature for additional 30 minutes and then filtered and washed with de-ionised water. The filter cake was dried overnight at 120° C. and then calcined at 850° C.

100 g of composite oxide was obtained. The mixed composite oxide obtained was pulverized in an agate mortar and sieved through 100 μm sieve. BET was measured at 850° C./4 hours (fresh material) and 1100° C./4 hours.

BET (fresh prepared material): 75 m²/g

BET (after ageing at 1100° C./4 hours): 0.7 m²/g

C) Preparation of Composite Oxide Al₂O₃ (30%) ZrO₂(40%) CeO₂(30%)

222.2 g of aluminium nitrate nonahydrate (Al₂O₃ 13.5%), 161.29 g of zirconyl-nitrate solution (ZrO₂ 24.8%) and 106.38 g of cerium nitrate solution (CeO₂ 28.2%) were dissolved in 1264.5 mL of deionised water and the mixture obtained was stirred for a few minutes until the solution became clear. To the aqueous mixed metal nitrate solution obtained 210.17 mL of cooled (10° C.) 35% H₂O₂ was added and the mixture obtained was stirred for approximately 45 minutes. Precipitation was done by adding drop wise 24% aqueous ammonia solution (10° C.) at room temperature with a dropping rate of 40 mL/minute and a pH of 10 was adjusted. The precipitate obtained was stirred at room temperature for additional 30 minutes and then filtered and washed with de-ionised water. The filter cake obtained was dried overnight at 120° C. and then calcined at 850° C. 50 g of composite oxide was obtained. The mixed composite oxide obtained was pulverized in an agate mortar and sieved through 100 μm sieve. BET was measured at 850° C./4 hours (fresh material) and 1100° C./4 hours.

BET (fresh prepared material): 85.9 m²/g

BET (after ageing) at 1100° C./4 hours: 15.3 m²/g

### EXAMPLE 1

### SCR Catalyst Containing 50 wt % of Composite Oxide Obtained According to A) and 50 wt % of Cu-Zeolite (Type BEA)

In order to prepare 20 g of SCR catalyst powder, 10 g of freshly prepared ceria/zirconia/alumina composite oxide prepared according to example A) were physically mixed with 10 g of Cu-zeolite ex Clariant (Type BEA; LOI 3.5%; BET 560 m²/g; d50 as 2.47 μm) in an agate mortar and considered as fresh catalyst powder for measurement of NOₓ conversion. 10 g of the SCR catalyst powder thus obtained were aged by calcining at 700° C./10 hours and referred to as aged catalyst. NOₓ conversion was also measured after ageing.

### EXAMPLE 2

### SCR Catalyst Containing 75 wt % of Composite Oxide Obtained According to A) and 25 wt % of Cu-Zeolite (Type BEA)

In order to prepare 20 g of SCR catalyst powder, 15 g of freshly prepared ceria/zirconia/alumina composite oxide prepared according to example A) were physically mixed with 5 g of Cu-zeolite ex Clariant (Type BEA; LOI 3.5%; BET 560 m²/g; d50 as 2.47 μm) in an agate mortar and considered as fresh catalyst powder for measurement of NOₓ conversion. 10 g of the SCR catalyst powder thus obtained were aged by calcining at 700° C./10 hours and referred to as aged catalyst for measurement of NOₓ.

### EXAMPLE 3

### SCR Catalyst Containing 80 wt % of Composite Oxide Obtained According to A) and 20 wt % of Cu-Zeolite (Type BEA)

In order to prepare 20 g of SCR catalyst powder, 16 g of freshly prepared ceria/zirconia/alumina composite oxide prepared according to example A) were physically mixed with 4 g of Cu-zeolite ex Clariant (Type BEA; LOI 3.5%; BET 560 m²/g; d50 as 2.47 μm) in an agate mortar and considered as fresh catalyst powder. 10 g of the SCR catalyst powder obtained were aged by calcining at 700° C./10 hours and referred to as aged catalyst. NOₓ conversion was measured in both fresh and aged catalysts.

### EXAMPLE 4

### SCR Catalyst Containing 85 wt % of Composite Oxide Obtained According to A) and 15 wt % of Cu-Zeolite (Type BEA)

In order to prepare 20 g of SCR catalyst powder, 17 g of freshly prepared ceria/zirconia/alumina composite oxide as prepared according to example A) were physically mixed with 3 g of Cu-zeolite ex Clariant (Type BEA; LOI 3.5%; BET 560 m²/g; d50 as 2.47 μm) in an agate mortar and considered as fresh catalyst powder. 10 g of the SCR catalyst powder obtained were aged by calcining at 700° C./10 hours and referred to as aged catalyst. NOₓ conversion was measured in both fresh as well as aged catalyst.

### EXAMPLE 5

### SCR Catalyst Containing 90 wt % of Composite Oxide Obtained According to A) and 10 wt % of Cu-Zeolite (Type BEA)

In order to prepare 20 g of SCR catalyst powder, 18 g of freshly prepared ceria/zirconia/alumina composite oxide as prepared according to example A) were physically mixed with 2 g of Cu-zeolite ex Clariant (Type BEA; LOI 3.5%; BET 560 m²/g; d50 as 2.47 μm) in an agate mortar and considered as fresh catalyst powder.

10 g of the SCR catalyst powder as obtained were aged by calcining at 700° C./10 hours and referred to as aged catalyst. NOₓ conversion was measured in both fresh as well as aged catalyst.

### EXAMPLE 6

### SCR Catalyst Containing 50 wt % of Composite Oxide Obtained According to B) and 50 wt % of Cu-Zeolite (Type BEA)

In order to prepare 20 g of SCR catalyst powder, 10 g of freshly prepared ceria/zirconia/alumina composite oxide prepared according to example B) were physically mixed with 10 g of Cu-zeolite ex Clariant (Type BEA; LOI 3.5%; BET 560 m²/g; d50 as 2.47 μm) in an agate mortar and considered as fresh catalyst powder for measurement of NOₓ activity. 10 g of the SCR catalyst powder as obtained were aged by calcining at 700° C./10 hours and referred to as aged catalyst. Aged catalyst was also tested for NOₓ conversion activity.

### EXAMPLE 7

### SCR Catalyst Containing 50 wt % of Composite Oxide Obtained According to C) and 50 wt % of Cu-Zeolite (Type BEA)

In order to prepare 20 g of SCR catalyst powder, 10 g of freshly prepared ceria/zirconia/alumina composite oxide obtained according to example C) were physically mixed with 10 g of Cu-zeolite ex Clariant (Type BEA; LOI 3.5%; BET 560 m²/g; d50 as 2.47 μm) in an agate mortar and considered as fresh catalyst powder for measurement of NOₓ conversion. 10 g of the SCR catalyst powder obtained were aged by calcining at 700° C./10 hours and referred to as aged catalyst for NOₓ conversion measurement.

### EXAMPLE 8

### SCR Catalyst Containing 50 wt % of Composite Oxide Obtained According to A) and 50 wt % of Fe-Zeolite (Type BEA)

In order to prepare 20 g of SCR catalyst powder, 10 g of freshly ceria/zirconia/alumina composite oxide prepared according to example A) were physically mixed with 10 g of Fe-zeolite ex Clariant (Type BEA; LOI 7.0%; BET 579 m²/g; d50 as 5.8 μm) in an agate mortar and considered as fresh catalyst powder. 10 g of the SCR catalyst powder as obtained were aged by calcining at 700° C./10 hours and referred to as aged catalyst. NOₓ conversion was measured for both fresh as well as aged catalyst.

### EXAMPLE 9

### SCR Catalyst Containing 50 wt % of Composite Oxide Obtained According to B) and 50 wt % of Fe-Zeolite (Type MFI)

In order to prepare 20 g of SCR catalyst powder, 10 g of freshly prepared ceria/zirconia/alumina composite oxide prepared according to example B) were physically mixed with 10 g of Fe-zeolite ex Clariant (Type MFI; LOI 7.5%; BET 373 m²/g; d50 as 5.8 μm) in an agate mortar and considered as fresh catalyst powder. 10 g of the SCR catalyst powder obtained were aged by calcining at 700° C./10 hours and referred to as aged catalyst. NOₓ conversion was measured for both fresh as well as aged catalyst.

### EXAMPLE 10

### SCR Catalyst Containing 50 wt % of Composite Oxide Prepared According to C) and 50 wt % of Fe-Zeolite (Type MFI)

In order to prepare 20 g of SCR catalyst powder, 10 g of freshly prepared ceria/zirconia/alumina composite oxide prepared according to example C) were physically mixed with 10 g of Fe-zeolite ex Clariant (Type MFI; LOI 7.5%; BET 373 m²/g; d50 as 5.8 μm) in an agate mortar and considered as fresh catalyst powder. 10 g of the SCR catalyst powder as obtained were aged by calcining at 700° C./10 hours and referred to as aged catalyst. NOₓ conversion was measured for both fresh as well as aged catalyst.

### EXAMPLE 11

SCR Catalyst Containing 50 wt % of Composite Oxide Al₂O₃ (52.9%) ZrO₂ (30.4%) CeO₂ (14.5%) Nd₂O₃ (2.2%)—“Enhanced Material”—and 50 wt % of Cu-Zeolite (Type BEA)
a) Preparation of Ce/Zr/Rare Earth—Hydroxide (Wet Cake) CeO₂(30%) ZrO₂(65%) Nd₂O₃(5%)/Total Oxide

1,541 kg of Cerium Nitrate solution (CeO₂ content=29.2%), 4,557 kg of Zirconyl nitrate solution (ZrO₂ content=21.4%) and 0.196 kg of neodymium nitrate as crystals (Nd₂O₃ content=38.3%) are mixed resp. dissolved in 20 kg of deionised water. The mixture was stirred for 10 minutes to get a clear solution. 0.762 kg of H₂O₂ was added to mixed metal nitrate solution and mixture was stirred for 45 minutes. Co-precipitation was done by addition of 18% ammonium hydroxide under vigorous stirring till pH of 8.5 was obtained. The precipitate was stirred for another half an hour and was filtered via a filter press and washed with deionised water.

ROI (Residue on Ignition at 1000° C./2 hrs)=19.5%

Yield=approx. 7.69 kg of wet cake corresponding to 1.5 kg of Total Oxide

b) Preparation of Composite Oxide Al₂O₃ (52.9%) ZrO₂ (30.4%) CeO₂ (14.5%) Nd₂O₃ (2.2%)

228.4 g of the wet cake (corresponding to 45 g of oxide) prepared under a) was suspended in 670 ml of deionized water and the mixture was stirred using an external stirrer for 15 minutes. The suspension was added to 937.5 g of an aqueous Boehmite Suspension of commercially available Disperal HP14* with an Al₂O₃ content of 4.8 wt. %. The aqueous suspension obtained was stirred vigorously using an external stirrer for 30 minutes, spray dried and calcined at 850° C. for 4 hours (=fresh material). BET was measured of fresh material and material calcined 1100° C./4 hours (aged material).

BET (fresh material): 102 m²/g

BET (after ageing) at 1100° C./4 hours: 47 m²/g

*The manufacture of (commercially available) Boehmite Disperal HP14 is disclosed in WO 2013/007809.

c) SCR Catalyst Containing 50 wt % of Composite Oxide Al₂O₃ (52.9%) ZrO₂ (30.4%) CeO₂ (14.5%) Nd₂O₃ (2.2%) and 50 wt % of Cu-Zeolite (Type BEA)

In order to prepare 20 g of SCR catalyst powder, 10 g of freshly prepared alumina/ceria/zirconia composite oxide prepared according to b) were physically mixed with 10 g of Cu-zeolite ex Clariant (Type BEA; LOI 3.5%; BET 560 m²/g; d50 as 2.47 μm) in an agate mortar and considered as fresh catalyst powder for measurement of NOₓ conversion. 10 g of the SCR catalyst powder thus obtained were aged by calcining at 700° C./10 hours and referred to as aged catalyst. NOₓ conversion was also measured after ageing.

### COMPARATIVE EXAMPLE 1

### NOₓ Conversion of Ceria/Zirconia/Alumina Composite Oxide

NOₓ conversion was measured using freshly prepared ceria/zirconia/alumina composite oxide as prepared according to example A) (referred to as fresh catalyst).

The composite oxide was aged at 700° C./10 hours and NOₓ conversion was measured again (referred to as aged catalyst).

### COMPARATIVE EXAMPLE 2

NOₓ conversion of Cu-zeolite (type BEA; LOI 3.5%; ex Clariant

In comparative example 2 NOₓ conversion was measured using Cu-zeolite (type BEA; LOI 3.5%; ex Clariant) as it is (referred to as fresh catalyst).

Cu-zeolite was aged at 700° C./10 hours and NOₓ conversion was measured again (referred to as aged catalyst).

### COMPARATIVE EXAMPLE 3

SCR catalyst containing 75 wt % of γ-Alumina (PURALOX, SASOL) and 25 wt % of Cu-zeolite (type BEA; LOI 3.5%; ex Clariant).

20 g of SCR catalyst powder were prepared by physically mixing 15 g of γ-Alumina (PURALOX, BET 80-160 m²/g ex SASOL) and 5 g of Cu-zeolite (type BEA; LOI 3.5%; ex Clariant) in an agate mortar considered as fresh catalyst and tested for NOₓ conversion activity. 10 g of the SCR catalyst powder obtained were aged at 700° C./10 hours and NOₓ conversion was measured again (referred to as aged catalyst).

### COMPARATIVE EXAMPLE 4

SCR Catalyst Containing 75 wt % of [50% Al₂O₃-15% CeO₂-32.5% ZrO₂-2.5% Nd₂O₃-Oxide Mixture [Prepared by Physically Mixing the Individual Oxides] and 25 wt % of Cu-Zeolite (Type BEA; LOI 3.5%; Ex Clariant).
a) Synthesis of the Oxide Mixture [50% Al₂O₃-15% CeO₂-32.5% ZrO₂-2.5% Nd₂O₃]

All oxides used as a starting material were passed through a 100Ξ sieve before mixing. In order to make 25 g of oxide mixture, 12.5 g Al₂O₃ (99.99%), 3.75 g CeO₂ (99.99%), 8.13 g of ZrO₂ (99.99%) and 0.63 g Nd₂O₃(99.99%) were physically mixed in an agate mortar and then heat treated at 850° C./4 h.

b) SCR catalyst containing 75 wt % of [50% Al₂O₃-15% CeO₂-32.5% ZrO₂-2.5% Nd₂O₃]—Oxide Mixture and 25 wt % of Cu-Zeolite (type BEA; LOI 3.5%; ex Clariant).

20 g of SCR catalyst powder were prepared by physically mixing 15 g of oxide mixture [50% Al₂O₃-15% CeO₂-32.5% ZrO₂-2.5% Nd₂O₃—prepared as described under a) and 5 g of Cu-Zeolite (type BEA; LOI 3.5%; ex Clariant) in an agate mortar.

The SCR catalyst mixture was tested for NOₓ conversion activity.

### Results of Catalytic Testing of SCR Catalysts Powders:

Testing was performed according to the parameters as disclosed in Table 1 above.

In Table 2 below the NOₓ conversion in % at temperatures from 200 to 500° C. with a catalyst prepared according to examples 1 to 10 and comparative examples 1 to 3 under fresh and aged conditions is indicated. As a feed gas there was applied practically NO only (feedgas >90% NO).

TABLE 2

| Temp. ° C. | 200 | 230 | 250 | 270 | 300 | 320 | 350 | 380 | 420 | 450 | 480 | 500 |
|---|---|---|---|---|---|---|---|---|---|---|---|---|
| Example 1 | 50% [50% Al₂O₃ − 15% CeO₂ − 32.5% ZrO₂ − 2.5% Nd₂O₃] + 50% Cu-zeolite | | | | | | | | | | | |
| Fresh | 96 | 100 | 100 | 100 | 100 | 100 | 100 | 92 | 88 | 83 | 76 | 73 |
| Aged | 91 | 98 | 99 | 99 | 99 | 99 | 99 | 94 | 91 | 88 | 85 | 81 |
| Example 2 | 75% [50% Al₂O₃ − 15% CeO₂ − 32.5% ZrO₂ − 2.5% Nd₂O₃] + 25% Cu-zeolite | | | | | | | | | | | |
| Fresh | 80 | 95 | 97 | 98 | 99 | 99 | 99 | 94 | 90 | 87 | 82 | 78 |
| Aged | 64 | 88 | 92 | 94 | 96 | 99 | 97 | 96 | 93 | 91 | 89 | 86 |
| Example 3 | 80% [50% Al₂O₃ − 15% CeO₂ − 32.5% ZrO₂ − 2.5% Nd₂O₃] + 20% Cu-zeolite | | | | | | | | | | | |
| Fresh | 73 | 93 | 96 | 97 | 98 | 99 | 92 | 88 | 86 | 81 | 75 | 72 |
| Aged | 54 | 76 | 82 | 85 | 88 | 89 | 90 | 90 | 89 | 89 | 87 | 84 |
| Example 4 | 85% [50%Al₂O₃ − 15% CeO₂ − 32.5% ZrO₂ − 2.5% Nd₂O₃] + 15% Cu-zeolite | | | | | | | | | | | |
| Fresh | 69 | 88 | 92 | 95 | 96 | 97 | 92 | 89 | 85 | 81 | 75 | 71 |
| Aged | 46 | 68 | 76 | 80 | 85 | 87 | 90 | 90 | 89 | 88 | 86 | 83 |
| Example 5 | 90% [50% Al₂O₃ − 15% CeO₂ − 32.5% ZrO₂ − 2.5% Nd₂O₃] + 10% Cu-zeolite | | | | | | | | | | | |
| Fresh | 42 | 71 | 80 | 85 | 89 | 92 | 91 | 88 | 85 | 81 | 75 | 71 |
| Aged | 26 | 46 | 55 | 61 | 68 | 73 | 81 | 87 | 88 | 89 | 87 | 85 |
| Example 6 | 50% [Al₂O₃(50%) − ZrO₂(20%) − CeO₂(20%) − Bi₂O₃(10%)] + 50% Cu-zeolite | | | | | | | | | | | |
| Fresh | 97 | 100 | 100 | 100 | 100 | 100 | 100 | 93 | 88 | 83 | 77 | 72 |
| Aged | 94 | 99 | 100 | 100 | 100 | 100 | 100 | 94 | 90 | 87 | 83 | 80 |
| Example 7 | 50% [Al₂O₃(30%) − ZrO₂(40%) − CeO₂(30%)] + 50% Cu-zeolite | | | | | | | | | | | |
| Fresh | 90 | 99 | 100 | 100 | 100 | 100 | 100 | 92 | 88 | 84 | 77 | 73 |
| Aged | 83 | 97 | 99 | 99 | 99 | 99 | 99 | 96 | 92 | 89 | 85 | 81 |
| Example 8 | 50% [50% Al₂O₃ − 15% CeO₂ − 32.5% ZrO₂ − 2.5% Nd₂O₃] + 50% Fe-zeolite (BEA) | | | | | | | | | | | |
| Fresh | 6 | 25 | 43 | 63 | 87 | 95 | 98 | 97 | 95 | 95 | 95 | 93 |
| Aged | 6 | 21 | 35 | 53 | 79 | 88 | 93 | 94 | 95 | 95 | 95 | 93 |
| Example 9 | 50% [Al₂O₃(50%) − ZrO₂(20%) − CeO₂(20%) − Bi₂O₃(10%)] 50% Fe-zeolite (MFI) | | | | | | | | | | | |
| Fresh | 19 | 63 | 85 | 95 | 99 | 99 | 99 | 85 | 85 | 85 | 85 | 85 |
| Aged | 34 | 63 | 82 | 93 | 98 | 99 | 98 | 93 | 93 | 93 | 93 | 93 |
| Example 10 | 50% [Al₂O₃(30%) − ZrO₂(40%) − CeO₂(30%)] + 50% Fe-zeolite (MFI) | | | | | | | | | | | |
| Fresh | 16 | 55 | 82 | 96 | 100 | 100 | 100 | 90 | 90 | 90 | 92 | 92 |
| Aged | 22 | 53 | 73 | 89 | 98 | 99 | 99 | 93 | 93 | 93 | 93 | 93 |
| Example 11 | 50% [Al₂O₃(52.9%) − ZrO₂(30.4%) − CeO₂(14.5%) − Nd₂O₃(2.2%)] + 50% Cu-Zeolite | | | | | | | | | | | |
| Fresh | 97 | 99 | 99 | 99 | 99 | 99 | 99 | 94 | 91 | 87 | 82 | 79 |
| Aged | 86 | 95 | 97 | 98 | 98 | 98 | 98 | 98 | 95 | 93 | 91 | 88 |
| Comp. Ex. 1 | 100% Composite Oxide (50% Al₂O₃ − 15% CeO₂ − 32.5% ZrO₂ − 2.5% Nd₂O₃) | | | | | | | | | | | |
| Fresh | 0 | 0 | 0 | 2 | 6 | 11 | 20 | 32 | 46 | 52 | 49 | 43 |
| Aged | 0 | 0 | 1 | 2 | 7 | 11 | 21 | 32 | 43 | 47 | 44 | 38 |
| Comp. Ex. 2 | 100% Cu-zeolite | | | | | | | | | | | |
| Fresh | 94 | 100 | 100 | 100 | 100 | 100 | 100 | 92 | 88 | 83 | 77 | 71 |
| Aged | 93 | 99 | 99 | 99 | 99 | 99 | 99 | 95 | 90 | 86 | 81 | 77 |
| Comp. Ex. 3 | 75% γ-Al₂O₃ + 25% Cu-zeolite | | | | | | | | | | | |
| Fresh | 74 | 90 | 94 | 95 | 97 | 97 | 93 | 88 | 86 | 83 | 78 | 76 |
| Aged | 29 | 47 | 55 | 63 | 74 | 81 | 88 | 90 | 87 | 84 | 77 | 70 |
| Comp. | 75% [50% Al₂O₃ − 15% CeO₂ − 32.5% ZrO₂ − 2.5% Nd₂O₃ out of individual Oxides] + | | | | | | | | | | | |
| Example 4 | 25% Cu-Zeolite | | | | | | | | | | | |
| Fresh | 78 | 92 | 95 | 96 | 98 | 98 | 90 | 89 | 85 | 80 | 75 | 70 |

1. A catalyst composition comprising a mixture of
(a) a zeolite compound in an amount of 10% to 60% by weight, wherein the zeolite compound comprises cations selected from Fe²⁺, Fe³⁺, Cu⁺, Cu²⁺ or mixtures thereof,
(b) a ceria/zirconia/alumina composite oxide, wherein the alumina content in said composite oxide is in the range of 20 to 80% by weight.

2. A catalyst composition according to claim 1, consisting of (a) and (b).

3. A catalyst composition according to claim 1, wherein
the amount of the zeolite compound in said composition is in the range from 25 to 55% by weight.

4. A catalyst composition according to claim 3, wherein the amount of the zeolite compound in said composition is in the range from 30 to 50% by weight.

5. A catalyst composition according to claim 1, wherein the ceria/zirconia/alumina composite oxide is of formula
(Al₂O₃)ₓ(CeO₂)_{y}(ZrO₂)_{z}(M-oxide)ₐ
wherein,
x denotes a number from 20% to 80% by weight;
y denotes a number from 5% to 40% by weight,
z denotes a number from 5% to 40% by weight, and
a denotes a number from 0% to 15% by weight,
with the proviso that x+y+z+a=100% by weight, and
M denotes a rare earth metal cation other than a Ce cation, an earth alkali metal cation, or a cation selected from a Mn, Fe, Ti, Sb or Bi cation, or M denotes individual mixtures of such cations.

6. A catalyst composition according to claim 1, wherein the amount of the cations selected from Fe²⁺, Fe³⁺, Cu⁺, Cu²⁺ or mixtures thereof in the zeolite is from 0.05-15 weight % of the metal, based on the weight of the zeolite including the cations.

7. A catalyst comprising a substrate coated with a catalyst composition according to claim 1.

8. A catalyst according to claim 7, wherein the substrate is selected from the group consisting of cordierite, mullite, Al-Titanate, and SiC.

9. A method of using a catalyst according to claim 7, comprising contacting and after treating exhaust gas of a diesel or a lean burn engine by the catalyst.

10. The method according to claim 9, wherein after treating exhaust gas comprises Selective Catalytic Reduction (SCR) of NOₓ in the exhaust gases.

11. A catalyst composition according to claim 1, wherein the alumina content in said composite oxide is in the range of 40 to 60% by weight.

12. A catalyst composition according to claim 5, wherein M comprises an earth alkali metal cation selected from a Mg, Ca, Sr or Ba cation.

13. A catalyst composition according to claim 6, wherein the amount of the cations selected from Fe²⁺, Fe³⁺, Cu⁺, Cu²⁺ or mixtures thereof in the zeolite is from 0.1-10 weight % of the metal, based on the weight of the zeolite including the cations.

14. A catalyst composition according to claim 6, wherein the amount of the cations selected from Fe²⁺, Fe³⁺, Cu⁺, Cu²⁺ or mixtures thereof in the zeolite is from 1-6 weight % of the metal, based on the weight of the zeolite including the cations.

15. The method according to claim 9, wherein the exhaust gas is from diesel and lean burn engines of automotives or for non-road applications.
